(19) United States
(12) Patent Application Publication
(10) Pub. No.: US 2023/0364842 A1
(43) Pub. Date: Nov. 16, 2023

(54) MOLDING CONDITION SETTING DEVICE AND MOLDING CONDITION SETTING METHOD

(71) Applicant: FANUC CORPORATION, Yamanashi (JP)

(72) Inventor: Atsushi HORIUCHI, Yamanashi (JP)

(21) Appl. No.: 18/246,679

(22) PCT Filed: Oct. 15, 2021
(86) PCT No.: PCT/JP2021/038189

§ 371 Date: Mar. 27, 2023

(30) Foreign Application Priority Data
Oct. 20, 2020 (JP) 2020-175929

(51) Int. Cl. B29C 45/80; B29C 45/76; B29C 45/77

(52) U.S. Cl. CPC B29C 45/80; B29C 45/768; B29C 45/77; B29C 2045/7606; B29C 2945/76913; B29C 2945/76939

(57) ABSTRACT

A molding condition setting device acquires data showing a state of an injection molding machine, calculates a feature showing the state of the injection molding machine on a basis of the acquired data, and calculates a feature fluctuation rate obtained by normalizing the feature on a basis of a reference value selected from among the features according to a prescribed condition. Meanwhile, the molding condition setting device acquires information relating to a change of the value of the operation command item and stores history of the change, and generates and stores history information in which the calculated feature fluctuation rate and the information relating to the change of the value of the operation command item are associated with each other.

### RELATED APPLICATIONS

The present application is a National Phase of International Application No. PCT/JP2021/038189 filed Oct. 15, 2021, which claims priority to Japanese Application No. 2020-175929, filed Oct. 20, 2020.

### TECHNICAL FIELD

The present invention relates to a molding condition setting device and a molding condition setting method concerning an injection molding machine and, in particular, to a molding condition setting device and a molding condition setting method for assisting the setting of a molding condition with respect to the molding condition concerning the operation of an injection molding machine.

### BACKGROUND ART

In molding a molded article with the operation of an injection molding machine, an operator sets many molding conditions. The molding conditions include, for example, a mold opening/closing condition, an injection condition, a measurement condition, and a cylinder heating condition, which are necessary for operating the injection molding machine. The operator performs injection molding while changing various molding conditions, confirms whether an operation state such as a pressure and a temperature observed during the molding is good or bad, and examines a molded article. A series of the processes of setting the molding conditions is repeatedly performed until a high-quality molded article is obtained, and an operation command value is calculated for each of the molding conditions. Further, a molding condition is changed every time a defective molded article is molded even after automatic operation starts.

A technology in which the process of setting a molding condition is recorded as the change history of the molding condition and the change history is displayed on an operation screen to understand the change situation of the molding condition has been known. For example, it is disclosed in PTL 1 that setting change dates and times, setting change items, setting values before and after change are stored and displayed with respect to the change work of a setting value by an operator. It is disclosed in PTL 2 that molding conditions and the items of input molding failures are stored as history. It is disclosed in PTL 3 that the past setting value change history (dates, times, setting values before and after change) of a setting item to be changed is displayed together with the setting item when a molding condition is changed, to thereby perform a setting operation while seeing the setting value change history. Further, it is disclosed in PTL 4 that setting change history data and abnormality occurrence history data are stored for a past prescribed time, and that at least a production achievement rate, the presence or absence of the occurrence of abnormality, the presence or absence of the change of a molding condition, and a quality data trend graph are displayed on a common time axis.

Moreover, it is disclosed in PTL 5 that the change history of setting values is displayed for each of the types of the setting values. Further, it is disclosed in PTL 6 that events such as state changes occurring during an operation, the types and occurrence times of the events, and reference data (such as the operation states, manipulation contents, and measurement values of a machine) set in advance are stored and output.

### CITATION LIST

### Patent Literature

[PTL 1] Japanese Patent Application Laid-open Publication No. S62-197262
[PTL 2] Japanese Patent Application Laid-open Publication No. H01-244819
[PTL 3] Japanese Patent Application Laid-open Publication No. H07-241894
[PTL 4] Japanese Patent Application Laid-open Publication No. 2001-293761
[PTL 5] Japanese Patent Application Laid-open Publication No. 2001-129862
[PTL 6] Japanese Patent Application Laid-open Publication No. 2003-033958

### SUMMARY OF INVENTION

### Technical Problem

The setting work of a molding condition is setting work relying on operator's experience and hunch and requires much labor and manpower. Conventionally, the determination of an operation command value by the association of an operation command value obtained in past molding, an operation state (observation value) obtained in molding, and the change degree of an operation state has not been performed.

Therefore, a technology to assist the smooth setting operation of a molding condition in consideration of influence by the change of the molding condition, that is, an event (the change of an observation value) resulting from the change of an operation command value has been demanded.

### Solution to Problem

A molding condition setting device according to the present invention acquires the state of the operation movement of an injection molding machine as time-series data (such as a pressure, a current, and a speed) and calculates the features (such as a peak value and a statistical amount in a molding process) of the time-series data for each molding process. Subsequently, at a timing at which an operator inputs an operation command value relating to the operation of the injection molding machine as a molding condition, the operation command value and “feature fluctuation rates showing the change rates of features before and after the change of the operation command value” are associated with each other and stored as history information. In the input operation of a next operation command value, an operation command value close to the operation command value and feature fluctuation rates associated with the operation command value are extracted from the history information and then displayed on an operation screen.

An aspect of the present invention provides a molding condition setting device for setting a value of an operation command item as a molding condition relating to operation movement of an injection molding machine, the molding condition setting device including: a data acquirer configured to acquire data relating to a prescribed physical amount as data showing a state of the injection molding machine; a feature calculator configured to calculate features showing a characteristic of the state of the injection molding machine based on the data relating to the physical amount; a feature storage configured to store the feature; an fluctuation rate calculator configured to calculate a feature fluctuation rate obtained by normalizing the feature stored in the feature storage based on a reference value selected from among the features stored in the feature storage according to a prescribed condition set in advance; an input value acquirer configured to acquire information relating to a change of the value of the operation command item; and a history information storage that stores history of the change of the value of the operation command item as history information, wherein the fluctuation rate calculator generates history information in which the calculated feature fluctuation rate and the information relating to the change of the value of the operation command item acquired by the input value acquirer are associated with each other, and stores the generated history information in the history information storage.

Another aspect of the present invention provides a molding condition setting method for setting a value of an operation command item as a molding condition relating to operation movement of an injection molding machine, the molding condition setting method including: a step of acquiring data relating to a prescribed physical amount as data showing a state of the injection molding machine; a step of calculating a feature indicating a characteristic of the state of the injection molding machine based on the data relating to the physical amount; a step of calculating a feature fluctuation rate obtained by normalizing the feature based on a reference value selected from among the features according to a prescribed condition set in advance; a step of acquiring information relating to a change of the value of the operation command item; and a step of generating and storing history information in which the calculated feature fluctuation rate and the acquired information relating to the change of the value of the operation command item are associated with each other.

### Advantageous Effects of Invention

An aspect of the present invention allows the smooth setting operation of a molding condition in consideration of an event resulting from the change of an operation command value obtained in past molding and improves the operability of an injection molding machine and the working efficiency of an operator.

### BRIEF DESCRIPTION OF DRAWINGS

FIG. 1 is a schematic hardware configuration diagram of a molding condition setting device according to an embodiment.

FIG. 2 is a schematic configuration diagram of an injection molding machine.

FIG. 3 is a schematic function block diagram of the molding condition setting device according to a first embodiment.

FIG. 4 is a diagram showing an example of a molding cycle in which one molded article is manufactured.

FIG. 5 is a diagram showing an example of calculating features from one time-series data.

FIG. 6 is a diagram showing an example of calculating features from two or more time-series data.

FIG. 7 is a diagram showing an example of features stored in a feature storage.

FIG. 8 is a diagram for illustrating a method for calculating a feature fluctuation rate.

FIG. 9 is a diagram showing an example of history information stored in a history information storage.

FIG. 10 is a diagram showing an example of the change screen of an operation command value.

FIG. 11 is a diagram showing a display example of history information.

FIG. 12 is a diagram showing an example of an alert display.

### DESCRIPTION OF EMBODIMENTS

Hereinafter, embodiments of the present invention will be described together with the drawings.

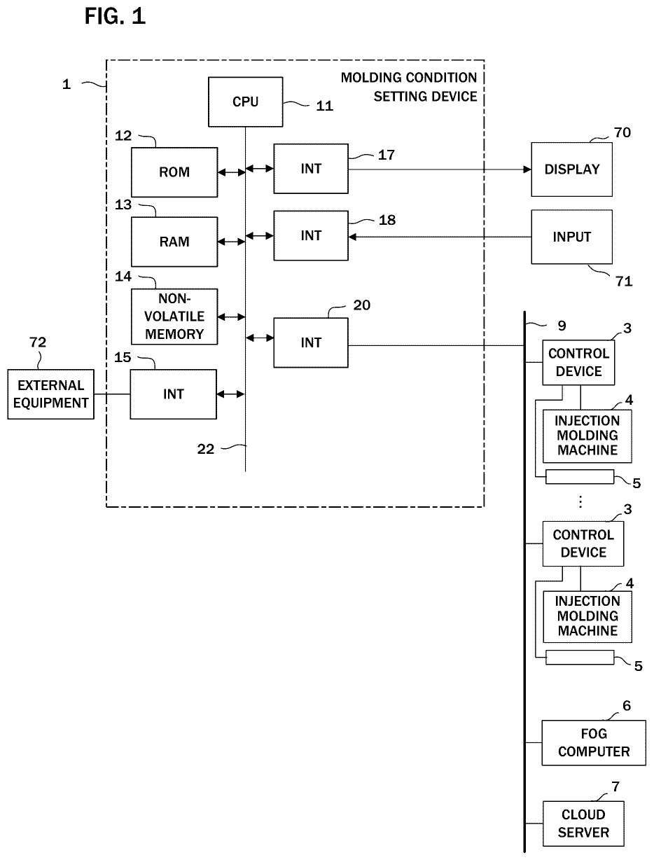

FIG. 1 is a schematic hardware configuration diagram showing the essential part of a molding condition setting device according to an embodiment of the present invention. A molding condition setting device 1 according to the present embodiment can be mounted as, for example, a control device for controlling an injection molding machine 4 on the basis of a control program. Alternatively, the molding condition setting device 1 can also be mounted on a higher device such as a personal computer annexed to a control device for controlling the injection molding machine 4 on the basis of a control program, a personal computer connected via a wired/wireless network to a control device, a cell computer, a fog computer 6, or a cloud server 7. The present embodiment shows an example in which the molding condition setting device 1 is mounted on a personal computer connected to the control device 3 via a network 9.

A CPU 11 included in the molding condition setting device 1 according to the present embodiment is a processor for entirely controlling the molding condition setting device 1. The CPU 11 reads a system program stored in a ROM 12 via a bus 22 and controls the entire molding condition setting device 1 according to the system program. In a RAM 13, temporary calculation data and display data, various data, input from an outside, and so on are temporarily stored.

A non-volatile memory 14 is configured by, for example, a memory, an SSD (Solid State Drive), or the like backed up by a battery not shown, and its storage state is maintained even when the power supply of the molding condition setting device 1 is turned off. In the non-volatile memory 14, data that are read from external equipment 72 via an interface 15, data that are input from an input device 71 via an interface 18, data acquired from the injection molding machine 4 via the network 9, and so on are stored. The stored data may include, for example, data relating to physical amounts such as the current, voltage, torque, position, speed, and acceleration of the motor in a driving unit, the pressure inside a mold, the temperature of an injection cylinder, the flow volume and flow rate of a resin, the vibration or sound of the driving unit that are detected by various sensors 5 attached to the injection molding machine 4 controlled by the control device 3. The data stored in the non-volatile memory 14 may be developed into the RAM 13 during executed or used. Further, various system programs such as known analysis programs are written in advance in the ROM 12.

The interface 15 is an interface used to connect the CPU 11 in the molding condition setting device 1 and the external equipment 72 such as an external storage medium to each other. From the external equipment 72, a system program or a program and a parameter, associated with the operation of the injection molding machine 4, and so on can be read. Further, data or the like generated or edited in the molding condition setting device 1 can be stored in an external storage medium (not shown) such as a CF card, a USB flash drive or the like via the external equipment 72.

An interface 20 is an interface used to connect the CPU 11 in the molding condition setting device 1 and the network 9 in a wired or wireless form to each other. The network 9 may be, for example, one that performs communication using a technology such as serial communication such as RS-485, Ethernet (registered trademark) communication, optical communication, wireless LAN, Wi-Fi (registered trademark), and Bluetooth (registered trademark). The control device 3 for controlling the injection molding machine 4, a fog computer 6, a cloud server 7, and so on are connected to the network 9, and these devices exchange data with the molding condition setting device 1.

On a display device 70, respective data read onto a memory, data obtained as a result of the running of a program, or the like is output via an interface 17 and displayed. Further, the input 71 configured by a keyboard, a pointing device, and so on transfers a command, data, or the like based on an operator's operation via the interface 18 to the CPU 11.

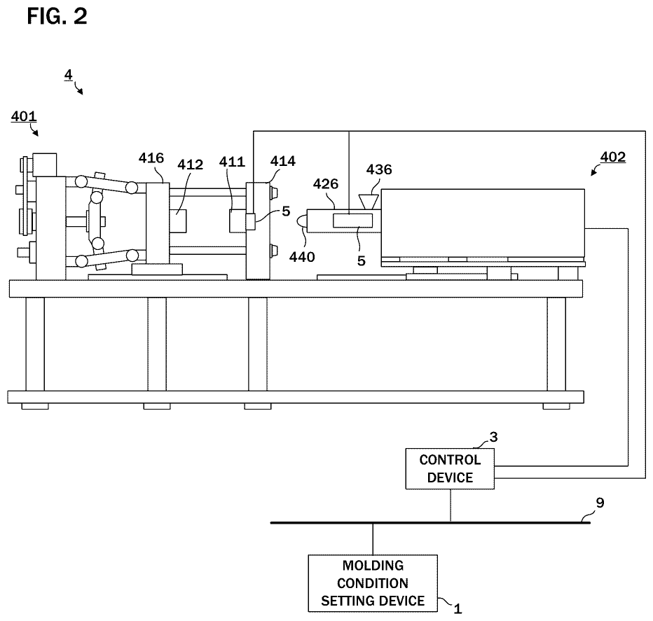

FIG. 2 is a schematic configuration diagram of the injection molding machine 4.

The injection molding machine 4 is mainly configured by a mold clamping unit 401 and an injection unit 402. The mold clamping unit 401 includes a movable platen 416 and a fixed platen 414. Further, a movable mold 412 is attached to the movable platen 416, and a fixed mold 411 is attached to the fixed platen 414. Meanwhile, the injection unit 402 is constituted by an injection cylinder 426, a hopper 436 for accumulating a resin material to be supplied to the injection cylinder 426, and a nozzle 440 provided at the tip of the injection cylinder 426. In a molding cycle in which one molded article is manufactured, the mold clamping unit 401 performs a mold closing/clamping operation by the movement of the movable platen 416, and the injection unit 402 injects a resin into a mold with the nozzle 440 pressed against the fixed mold 411. These operations are controlled according to a command from the control device 3.

Further, sensors 5 are attached to the respective units in the injection molding machine 4, and physical amounts such as the current, voltage, torque, position, speed, and acceleration of the motor in the driving unit, the pressure inside the mold, the temperature of the injection cylinder 426, the flow volume and flow rate of a resin, the vibration and sound of the driving unit are detected and transmitted to the control device 3. In the control device 3, the detected respective physical amounts are stored in a RAM, a non-volatile memory, or the like, not shown, and transmitted via the network 9 to the molding condition setting device 1 where necessary.

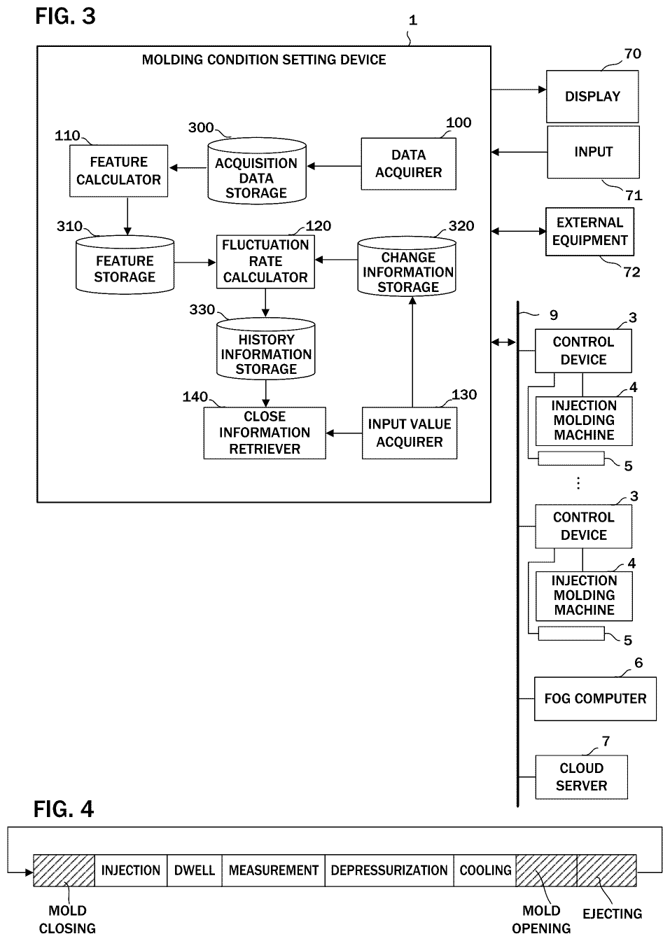

FIG. 3 shows a schematic block diagram of functions included in the molding condition setting device 1 according to a first embodiment of the present invention.

The respective functions included in the molding condition setting device 1 according to the present embodiment are actualized when the CPU 11 included in the molding condition setting device 1 shown in FIG. 1 runs the system program and controls the operations of the respective units in the molding condition setting device 1.

The molding condition setting device 1 of the present embodiment includes a data acquirer 100, a feature calculator 110, a fluctuation rate calculator 120, an input value acquirer 130, and a close information retriever 140. Further, in the RAM 13 and the non-volatile memory 14 in the molding condition setting device 1, an acquisition data storage 300 serving as a region to store data acquired by the data acquirer 100 from the control device 3 and so on, a feature storage 310 serving as a region to store a feature calculated by the feature calculator 110, a change information storage 320 serving as a region to store information relating to the change of the value of an operation command item (hereinafter simply called an “operation command value”) acquired by the input value acquirer 130, and a history information storage 330 serving as a region to store data calculated by the fluctuation rate calculator 120 are provided in advance.

The data acquirer 100 is actualized when the CPU 11 included in the molding condition setting device 1 shown in FIG. 1 runs the system program that is read from the ROM 12 and mainly performs computation processing using the RAM 13 and the non-volatile memory 14 and input control processing using the interface 15, 18, or 20.

The data acquirer 100 acquires data relating to physical amounts such as the current, voltage, torque, position, speed, and acceleration of the motor in the driving unit, the pressure inside the mold, the temperature of the injection cylinder 426, the flow volume and flow rate of a resin, the vibration and sound of the driving unit that are detected by the sensors 5 attached to the injection molding machine 4. The data relating to the physical amounts acquired by the data acquirer 100 may be so-called time-series data showing the values of the physical amounts for each prescribed cycle. In acquiring the data relating to the physical amounts, the data acquirer 100 also acquires a production number (the number of shots) at the time when the physical amounts were detected. The production number (the number of shots) may be a production number (the number of shots) since the last maintenance.

The data acquirer 100 may directly acquire the data from the control device 3 that controls the injection molding machine 4 via the network 9, may acquire the data stored in the external equipment 72, the fog computer 6, the cloud server 7, or the like, or may acquire the data relating to the physical amounts for each process constituting one molding cycle by the injection molding machine 4.

FIG. 4 is a diagram illustrating a molding cycle in which one molded article is manufactured.

In FIG. 4, a mold closing process, a mold opening process, and an ejecting process, which are the processes shown by shaded frames, are performed in the operation of the mold clamping unit 401, and an injection process, a dwell process, a measurement process, a depressurization process, and a cooling process, which are the processes shown by void frames in the Figure, are performed in the operation of the injection unit 402.

The data acquirer 100 acquires the data relating to the physical amounts so as to be distinguishable for each of these processes. The data relating to the physical amounts acquired by the data acquirer 100 are stored in the acquisition data storage 300 in association with a production number (the number of shots) by the injection molding machine 4.

The feature calculator 110 is actualized when the CPU 11 included in the molding condition setting device 1 shown in FIG. 1 runs the system program read from the ROM 12 and mainly performs the computation processing using the RAM 13 and the non-volatile memory 14. The feature calculator 110 calculates, on the basis of data relating to physical amounts showing the state of the injection molding machine 4 acquired by the data acquirer 100, the features of the data relating to the physical amounts (such as an injection time, a peak pressure, and a peak pressure reach position in the injection process, a dwell time, a dwell speed, and a peak pressure in the dwell process, a measurement pressure peak vale and a measurement end position in the measurement process, a mold closing time in the mold closing process, and a mold opening time in the mold opening process) for each process constituting the molding cycle of the injection molding machine 4. The features calculated by the feature calculator 110 show the characteristics of the states of the injection molding machine 4 for each process.

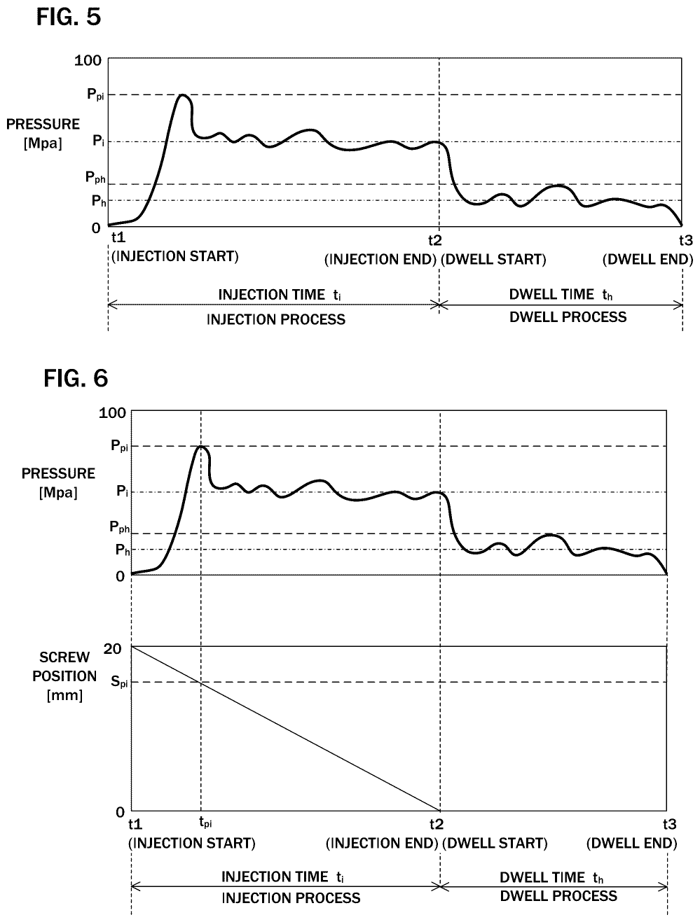

FIG. 5 is a graph showing the change of a pressure in the injection process and the dwell process. In FIG. 5, t1 shows the start point of the injection process, t2 shows the end point of the injection process and the start point of the dwell process, and t3 shows the end point of the dwell process. In the injection process, the pressure is controlled by the control device 3 in the injection molding machine 4 so as to start increasing along with the operation of injecting a resin inside the injection cylinder into the mold and then reach a prescribed target pressure Pᵢ. Further, in the dwell process, the pressure is controlled by the control device 3 in the injection molding machine 4 so as to be kept at a prescribed target pressure Pₕ to maintain the press-fitted state of the resin filled in a cavity (not shown) inside the mold. An injection target pressure Pᵢ, a dwell target pressure Pₕ, an injection time tᵢ, and a dwell time to are manually set in advance as operation command values based on an operator's operation when the operator operates the input 71 while visually confirming an operation screen displayed on the display 70. As shown in FIG. 5, the feature calculator 110 calculates the peak value (injection peak pressure Pₚᵢ) of time-series data showing a pressure acquired in the injection process and assumes the calculated peak value as the feature of a peak pressure in the injection process. Further, the feature calculator 110 calculates the peak value (dwell peak pressure Pₚₕ) of time-series data showing a pressure acquired in the dwell process and assumes the calculated peak value as the feature of a peak pressure in the dwell process.

FIG. 6 is a graph showing the change of a pressure and the change of a screw position in the injection process and the dwell process. As shown in FIG. 6, the feature calculator 110 calculates a peak pressure Pₚᵢ in the injection process and then calculates a screw position Sₚᵢ at a peak pressure reach time tₚᵢ at which the pressure has reached the peak pressure Pₚᵢ. The feature calculator 110 assumes the calculated screw position Sₚᵢ as the feature of the peak pressure reach position in the injection process.

As described above, the features calculated by the feature calculator 110 may be calculated on the basis of data relating to a prescribed physical amount in a prescribed process, or may be calculated from data relating to a plurality of physical amounts in a prescribed process.

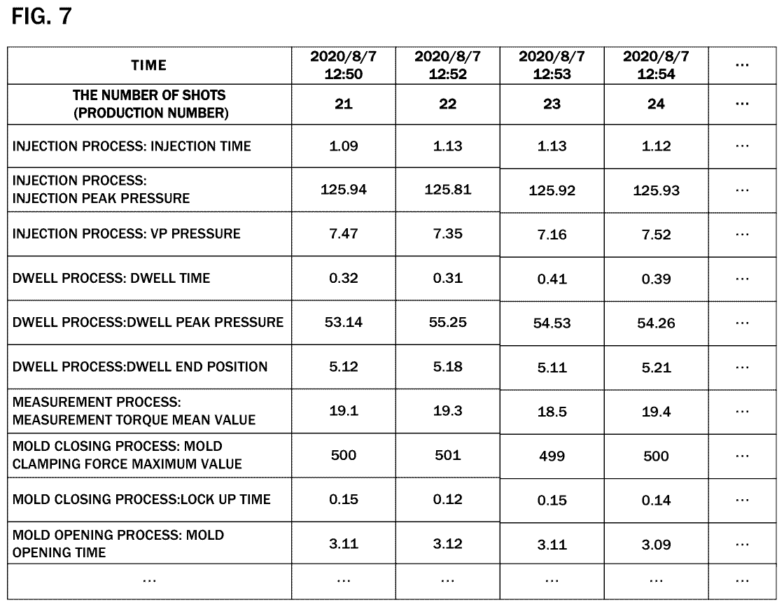

The features calculated by the feature calculator 110 are stored in the feature storage 310 in association with a production number (the number of shots) by the injection molding machine 4. FIG. 7 is a diagram showing an example of the features stored in the feature storage 310. As illustrated in FIG. 7, the features may be stored in association with times at which the features were detected.

Note that the features calculated by the feature calculator 110 may be statistical amounts calculated on the basis of features based on data relating to a prescribed physical amount or features based on data relating to a plurality of physical amounts. Here, the statistical amounts may include a weighted mean, an arithmetic mean, a weighted harmonic mean, a trimmed mean, a root-mean square, a minimum value, a maximum value, a mode, a weighted medium value, a variance, a standard deviation, an average deviation, a variation coefficient, and so on. The feature calculator 110 may calculate the statistical amounts serving as features on the basis of a plurality of features calculated in a plurality of successive production (shots). For example, it is possible to reduce the influence of an outlier (sudden molding failure) by assuming the mode of the injection peak pressure calculated in each of ten successive shots as a feature. Further, it is also possible to determine the variation degree of a molding state or the stable/unstable degree of molding by using a statistical amount such as a variance value. When statistical amounts are handled as features, the feature calculator 110 may calculate, for each prescribed production number (the number of shots) set in advance, the statistical amounts by means of using features detected in respective production (shots). When the statistical amounts are selected as the features as described above, the injection molding machine 4 may be caused to perform test operation in advance to analyze the correlation between the molding state of a molded article by the injection molding machine 4 and the respective statistical amounts calculated from the features and select an appropriate statistical amount on the basis of the analysis result.

The fluctuation rate calculator 120 is actualized when the CPU 11 included in the molding condition setting device 1 shown in FIG. 1 runs the system program read from the ROM 12 and mainly performs the computation processing using the RAM 13 and the non-volatile memory 14. The fluctuation rate calculator 120 calculates a feature fluctuation rate obtained by normalizing the fluctuation degree of a feature showing the characteristic of the state of the injection molding machine 4 calculated by the feature calculator 110. The feature fluctuation rate calculated by the fluctuation rate calculator 120 can be calculated by, for example, following Mathematical formula 1. In Mathematical formula 1, yₙ is a feature fluctuation rate in the n-th shot, xₙ is a feature in the n-th shot, and x₀ is a reference value set in advance.

$${y}_{n} = \frac{{x}_{n} - {x}_{0}}{{x}_{0}} \times 100 \qquad [ Mathematical formula 1 ]$$

The reference value x₀ is a reference value used to calculate a fluctuation degree and selected from among features according to a prescribed condition set in advance. The prescribed condition may be, for example, a condition under which an operator selects a specified one from among features (statistical amounts) stored in the feature storage 310. The prescribed condition may be a condition under which a feature (statistical amount) earlier by a prescribed production number (the number of shots) than the change of a prescribed operation command value is selected. Further, the prescribed condition may be a condition under which a feature (statistical amount) later by a prescribed production number (the number of shots) than the start of automatic operation is selected.

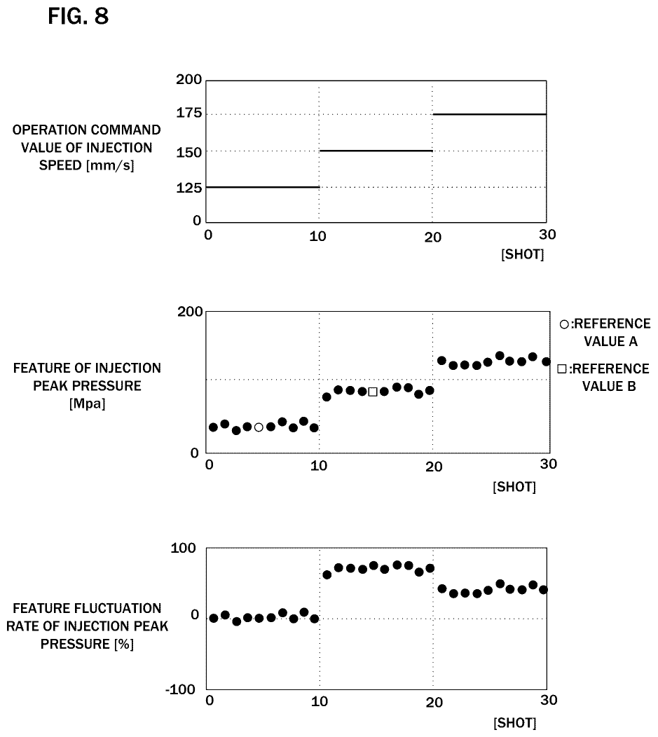

FIG. 8 is a graph illustrating as an example the change of a feature xₙ and the change of a feature fluctuation rate yₙ in a case in which an operation command value is changed. As illustrated in FIG. 8, an automatic operation starts with the injection speed set at 125 mm/s as the operation command value. The injection speed is changed to 150 mm/s at the end of a 10-shot molding operation. Moreover, the injection speed is changed to 175 mm/s at the end of a 20-shot molding operation. Then, consideration is given to a case in which the feature fluctuation rate of the injection peak pressure is calculated after a feature calculated on the basis of data relating to the physical amount acquired earlier by six shots than the change of the operation command value is set as a reference value xc. In this case, the value (reference value A) indicated by a white circle (o) in the Figure corresponds to the reference value x₀ when the injection speed is 150 mm/s, and the value (reference value B) indicated by a white rectangle (□) in the Figure corresponds to the reference value x₀ when the injection speed is 175 mm/s. Further, since there is no value before the change of the operation command value when the injection speed is 125 mm/s, the value (reference value A) of the white circle in the Figure is handled as the reference value x₀ for convenience. Then, the respective values are assigned to above Mathematical formula 1 to calculate the feature fluctuation rate of the injection peak pressure yₙ.

As illustrated in FIG. 8, the feature fluctuation rate yₙ shows the change of a feature with respect to the reference value x₀. Particularly, when a feature before the change of the operation command value is set as the reference value x₀, the change of the feature according to the change of the operation command value is easily understood.

Note that the feature fluctuation rate calculated by the fluctuation rate calculator 120 may be calculated by following Mathematical formula 2. When it is calculated using Mathematical formula 1, the feature fluctuation rate is shown with 0[%] as a reference. However, when it is calculated using Mathematical formula 2, the feature fluctuation rate is shown with 100[%] as a reference.

$${y}_{n} = \frac{{x}_{n}}{{x}_{0}} \times 100 \qquad [ Mathematical formula 2 ]$$

The feature fluctuation rate calculated by the fluctuation rate calculator 120 is stored in the history information storage 330 as history information associated with information relating to the change of an operation command value stored in the change information storage 320. The history information includes information relating to the change content of a changed operation command item (such as a combination of an operation command value before change and an operation command value after change, and a combination of an operation command value before change and the change amount of the operation command value) and information relating to respective feature fluctuation rates in a case in which the operation command value is changed. The fluctuation rate calculator 120 is not required to store history information in all molding cycles in the history information storage 330. Preferably, the fluctuation rate calculator 120 stores history information in a molding cycle after a prescribed production number set in advance elapses since the change of an operation command value. This is because a molding cycle is required to be repeatedly performed by several shots to dozens of shots until a molding operation is stabilized after the change of an operation command value depending on the type of a molded article, and a feature fluctuation rate obtained in a secured molding cycle is included in the history information.

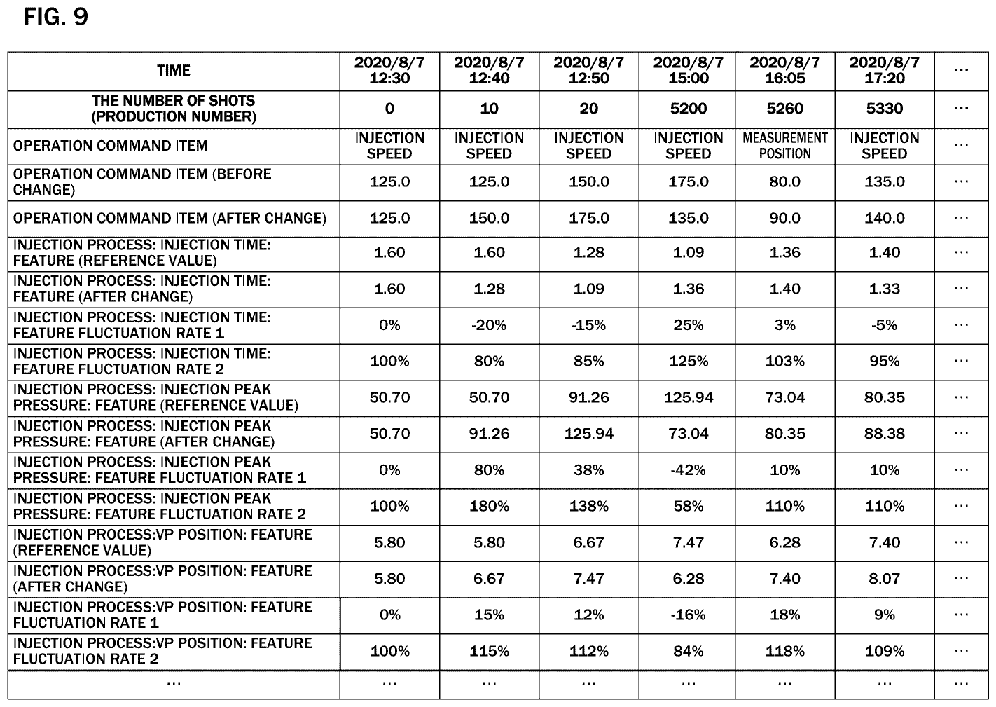

FIG. 9 shows an example of history information stored in the history information storage 330. In the example of FIG. 9, operation command values before and after the change of changed operation command items, the reference values and the values after the change of respective features, and feature fluctuation rates show the history information. Among the feature fluctuation rates illustrated in FIG. 9, feature fluctuation rates 1 are values calculated using Mathematical formula 1, and feature fluctuation rate 2 are values calculated using Mathematical formula 2. Note that the history information may be stored in association with times and production numbers (the number of shots) relating to the history information.

The input value acquirer 130 is actualized when the CPU 11 included in the molding condition setting device 1 shown in FIG. 1 runs the system program read from the ROM 12 and mainly performs the computation processing using the RAM 13 and the non-volatile memory 14 and input processing using the interface 18. The input value acquirer 130 acquires information relating to the change of an operation command value via the input 71 by an operator.

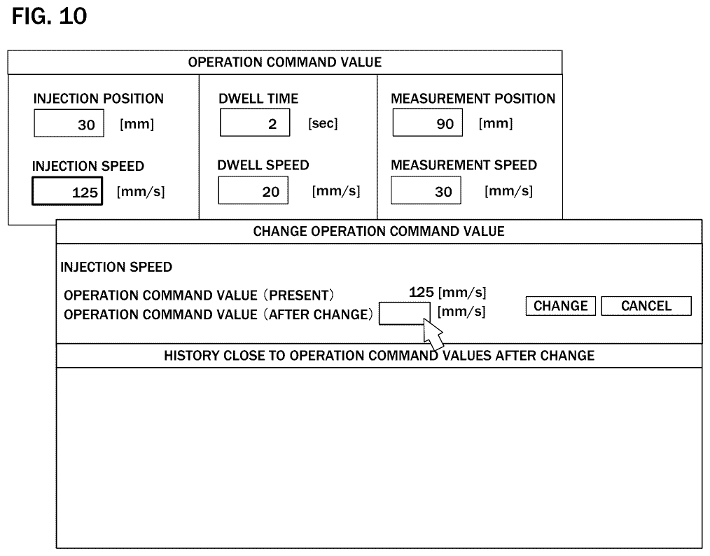

FIG. 10 shows an example of an input screen on which an operation command value is changed. When an operator selects an operation command item to be changed from the display screen for an operation command value displayed on the display 70, the change screen of the operation command value is displayed. Then, the operator inputs an operation command value after change to the input column of an operation command value (after change) arranged on the change screen of the operation command value by operating the input 71.

The input value acquirer 130 acquires, as information relating to the change of an operation command value, an identification value (an item ID, an item name, or the like) for identifying the item of a changed operation command value, an operation command value before change, and an input operation command value after change. The information relating to the change of the operation command value that the input value acquirer 130 acquires is output to the close information retriever 140. Further, when an operation command value is actually changed, a time and a production number (the number of shots) at which the change was made and information relating to the change of the operation command value that the input value acquirer 130 acquires are stored in the change information storage 320 in association with each other.

The close information retriever 140 is actualized when the CPU 11 included in the molding condition setting device 1 shown in FIG. 1 runs the system program read from the ROM 12 and mainly performs the computation processing using the RAM 13 and the non-volatile memory 14. The close information retriever 140 retrieves, with the acquisition of information relating to the change of an operation command value by the input value acquirer 130 as motivation, history information obtained when change close to the change of the operation command value was made from history information stored in the history information storage 330, and outputs the retrieved history information to the display 70. For the purpose of, for example, changing the same operation command item as information relating to the change of the operation command value acquired by the input value acquirer 130, the retriever 140 retrieves history information close to the operation command value before change. Then, the close information retriever 140 sorts a plurality of the retrieved history information in order of closeness to the operation command value before change, and displays the same on the display device 70. With this display, an operator is allowed to confirm history information close to an operation command value before change and therefore can preferentially refer to history information in accordance with a present situation. Further, the close information retriever 140 may sort the history information on the basis of other references and display the same.

For example, the close information retriever 140 may sort, for each of a plurality of retrieved history information, features in descending order of the absolute values of feature fluctuation rates included in the respective history information, and display the sorted features on the display device 70. Further, the retriever 140 may sort the history information in order in which the history information includes features of which the absolute values of feature fluctuation rates are large among a plurality of retrieved history information, and display the sorted history information on the display 70. With this display, the operator is allowed to preferentially refer to history information in which the features were largely fluctuated due to the change of an operation command value, and therefore can easily understand the input degree of an operation command value to obtain a desired fluctuation in the features. The above sorting display can be desirably switched by the operator through the operation of the input 71. Further, when the history information includes a time or a production number (the number of shots), the time or the production number (the number of shots) may be displayed on the display device 70 together with the operation command value. Thus, the operator is allowed to understand a time or a production number (the number of shots) at which an operation command value was changed.

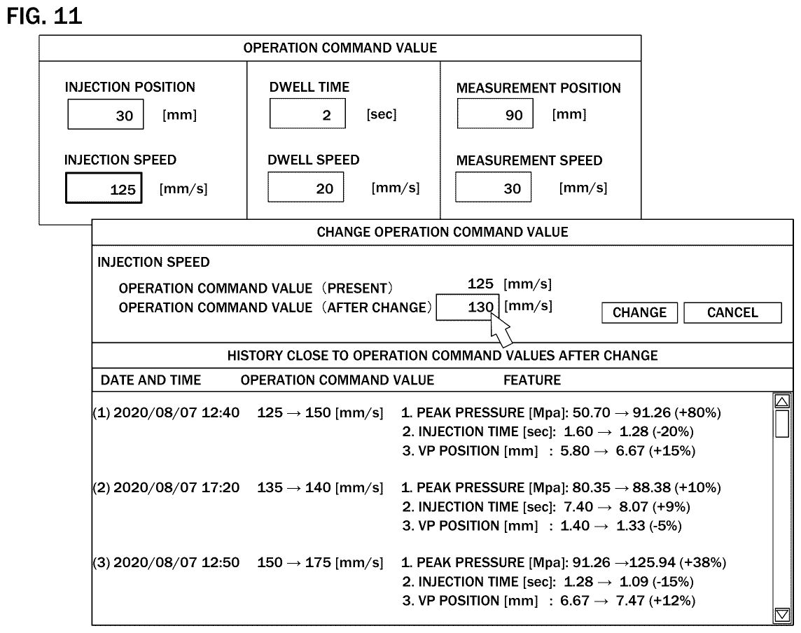

FIG. 11 is a display example of the retrieval result of history information by the close information retriever 140. In the example of FIG. 11, an injection speed is an operation command item to be changed. The operation command value before change was set at 125 mm/s and is about to be changed to 130 mm/s.

When an operator selects the injection speed as an operation command item to be changed from the display screen of the operation command value, the close information retriever 140 retrieves, with the injection speed showing the operation command item and 125 mm/s showing an operation command value before change as retrieval keys, history information in which the injection speed is changed as the operation command item and in which the operation command value before change is close to 125 mm/s from a plurality of history information (FIG. 9) stored in the history information storage 330. The example of FIG. 11 shows that history information in which the injection speed was changed from 125 mm/s to 150 mm/s at 12:40 on Aug. 7, 2020, is retrieved as history information closest to the retrieval keys and the fact is displayed on the change screen of the operation command value. When feature fluctuation rates are included in the retrieved history information at this time, features may be sorted in descending order of the feature fluctuation rates to display combinations of the sorted features and the feature fluctuation rates together with the operation command value. The example of FIG. 11 shows that the peak pressure was increased by 80%, the injection time was reduced by 20%, and the VP position was increased by 15%. Thus, the operator is allowed to refer to an operation command value close to the operation command value before change and the retrieval result of feature fluctuation rates resulting from the change of the operation command value to change the operation command value.

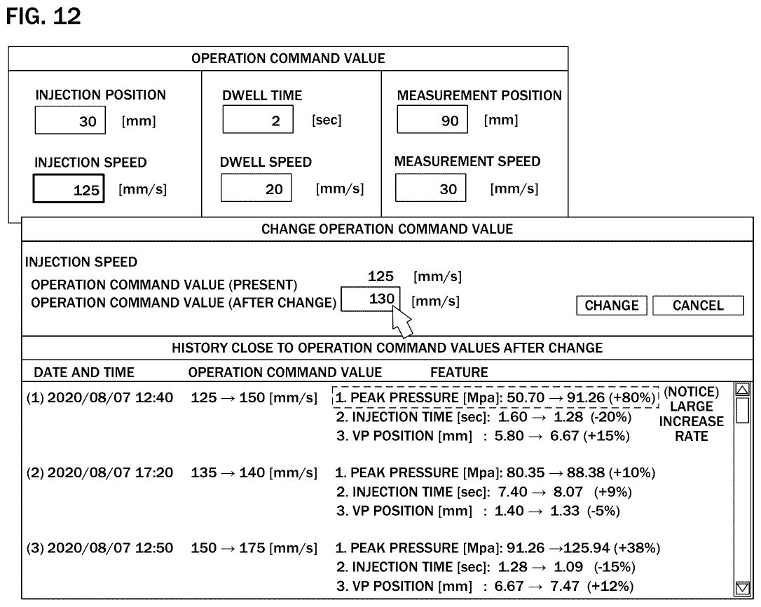

When close history information is displayed, history information in which the features were largely increased/decreased due to the change of an operation command value may be highlighted. For example, with the threshold of a feature fluctuation rate set in advance, history information in which the features were increased/decreased over the threshold may be displayed in a different color, underlined, surrounded by a rectangular graphic form, or displayed with an alert message. FIG. 12 is a display example of history information displayed with an alert message. In this example, the history information is set to be highlighted when a feature fluctuation rate exceeds ±70%. At this time, in the example of FIG. 12, the peak pressure of the feature is increased by 80% with the change of the operation command value in history information (1). Therefore, the periphery of a display content relating to the peak pressure is surrounded by a rectangular frame to be highlighted and displayed with an alert message “large fluctuation rate” in tandem with the highlighted display. With this display, the operator can easily identify an operation command item in which a feature largely fluctuates and pay attention to the change operation of an operation command value. Therefore, the operator is allowed to easily consider the change of an operation command value in a safe range.

The molding condition setting device 1 according to the present embodiment including the above configuration allows an operator to refer to the retrieval result of history information close to the situation of a present operation command value among history information obtained in past molding in the setting work of an operation command value, that is, a molding condition conventionally relying on experience and hunch and assists the operator to perform the setting work of an appropriate molding condition.

Specifically, when the setting operation of a molding condition is performed, history information in which “operation command values” and “feature fluctuation rates” obtained in past molding are associated with each other is displayed on the operation screen. Therefore, the operator is allowed to perform the setting operation of the molding condition (molding condition setting work) by referring to the history information. Thus, the operator is allowed to bear a less burden in the setting work of an operation command value by trial and error and smoothly and easily set an appropriate operation command value. Therefore, the operability of an injection molding machine and the working efficiency of the operator are improved. Further, the operator reduces the risk of falsely setting an inappropriate operation command value and is allowed to safely perform the operation of the injection molding machine. Moreover, since the possibility of molding a defective product due to an inappropriate operation command value reduces and a reduction in a production number until a high-quality molded article is obtained is made possible, a production cost and production efficiency can be improved.

The embodiment of the present invention is described above. However the present invention is not limited to the example of the above embodiment but can be carried out in various modes with the addition of appropriate modifications.

For example, when a plurality of injection molding machines 4 are connected to each other via the network 9, data may be acquired from the plurality of injection molding machines to determine the change of operation command values in the respective injection molding machines with one molding condition setting device 1. An example in which the molding condition setting device 1 is mounted on a higher management apparatus such as the fog computer 6 and the cloud server 7 will be taken into consideration. In this case, display devices and input devices provided in the respective injection molding machines 4 are used as display devices and input devices. When the change operations of operation command values are performed in the respective injection molding machines 4, the change contents are transmitted via the network 9 to the molding condition setting device 1. The molding condition setting device 1 retrieves history information from the history information storage 330 and transmits the retrieval result via the network 9 to the injection molding machines 4. An operator operating the injection molding machines 4 is allowed to retrieve the change of an appropriate operation command value while seeing the transmitted history information.

1. A molding condition setting device for setting a value of an operation command item as a molding condition relating to operation movement of an injection molding machine, the molding condition setting device comprising:
a data acquirer configured to acquire data relating to a prescribed physical amount as data showing a state of the injection molding machine;
a feature calculator configured to calculate a feature indicating a characteristic of the state of the injection molding machine based on the data relating to the physical amount;
a feature storage configured to store the feature;
a fluctuation rate calculator configured to calculate a feature fluctuation rate obtained by normalizing the feature stored in the feature storage based on a reference value selected from among the features stored in the feature storage according to a prescribed condition set in advance;
an input value acquirer configured to acquire information relating to a change of the value of the operation command item; and
a history information storage configured to store history of the change of the value of the operation command item as history information, wherein
the fluctuation rate calculator generates history information in which the calculated feature fluctuation rate and the information relating to the change of the value of the operation command item acquired by the input value acquirer are associated with each other, and stores the generated history information in the history information storage.

2. The molding condition setting device according to claim 1, further comprising:
a close information retriever configured to retrieve, from the history information storage, history information close to information relating to the change of the operation command item input from the input value acquirer, and outputs the retrieved history information.

3. The molding condition setting device according to claim 1, wherein
the feature calculated by the feature calculator includes a statistical amount calculated by performing statistical processing of any of a weighted mean, an arithmetic mean, a weighted harmonic mean, a trimmed mean, a root-mean square, a minimum value, a maximum value, a mode, a weighted medium value, a variance, a standard deviation, an average deviation, and a variation coefficient with respect to a feature calculated based on the data relating to the physical amount.

4. The molding condition setting device according to claim 1, wherein
the prescribed condition set in advance is a condition under which a feature earlier by a prescribed production number than the change of the value of the operation command item is selected.

5. The molding condition setting device according to claim 1, wherein
the fluctuation rate calculator stores a feature fluctuation rate, which is calculated later by a prescribed production number set in advance after the change of the value of the operation command item, in the history information storage as history information.

6. The molding condition setting device according to claim 2, wherein
the close information retriever retrieves history information close to a value before the change of the operation command item to which a value is input from the input value acquirer.

7. The molding condition setting device according to claim 2, wherein
the close information retriever outputs a retrieval result in which the retrieved history information is sorted in order of closeness to a value before the change of the operation command item to which a value is input from the input value acquirer.

8. The molding condition setting device according to claim 2, wherein
the close information retriever outputs a retrieval result in which a feature fluctuation rate included in retrieved history information is sorted in descending order of an absolute value of the feature fluctuation rate.

9. The molding condition setting device according to claim 1, wherein
the data acquirer acquires data from a plurality of injection molding machines connected via a wired or wireless network.

10. The molding condition setting device according to claim 1, wherein
the molding condition setting device is mounted on a management device that is connected via a wired or wireless network to the injection molding machine and manages the injection molding machine.

11. A molding condition setting method for setting a value of an operation command item as a molding condition relating to operation movement of an injection molding machine, the molding condition setting method comprising:
a step of acquiring data relating to a prescribed physical amount as data showing a state of the injection molding machine;
a step of calculating a feature indicating a characteristic of the state of the injection molding machine on a basis of the data relating to the physical amount;
a step of calculating a feature fluctuation rate obtained by normalizing the feature based on a reference value selected from among the features according to a prescribed condition set in advance;
a step of acquiring information relating to a change of the value of the operation command item; and
a step of generating and storing history information in which the calculated feature fluctuation rate and the acquired information relating to the change of the value of the operation command item are associated with each other.
